(19) United States
(12) Patent Application Publication
(10) Pub. No.: US 2004/0070599 A1
(43) Pub. Date: Apr. 15, 2004

(54) Data display unit for field devices

(75) Inventors: Hiroshi Mori, Tokyo (JP); Isao Hirooka, Tokyo (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: YOKOGAWA ELECTRIC CORPORATION, Tokyo (JP)

(21) Appl. No.: 10/654,926

(22) Filed: Sep. 5, 2003

(30) Foreign Application Priority Data
Sep. 26, 2002 (JP) 2002-280193

(51) Int. Cl. G09G 5/00

(52) U.S. Cl. 345/735

(57) ABSTRACT

The present invention is characterized by the following:

Definition files, which define the way diagnostic parameters and other information retained by field devices are displayed, are created. The parameters of field devices are displayed according to these definition files. By implementing these processes, a data display unit for use with field devices is realized, thereby making it possible to easily obtain parameters necessary to know the status of a field device without the need for in-depth knowledge about the parameters. It is also possible to identify parameters without having to go out to the site where the field device is installed.

### BACKGROUND OF THE INVENTION

1. Field of the Invention

The present invention relates to a data display unit used for field devices to display data, such as diagnostic parameters, that the field devices retain.

2. Description of the Prior Art

Distributed control systems have often been used to control plants. A distributed control system is configured in such a manner that an operation and monitoring station and field control stations are connected to a communication bus, the field control stations are distributed within a plant, and the plant is controlled by the field control stations under the supervision of the operation and monitoring station. Recently, it has also become popular to control plants using a fieldbus.

In plant control using a fieldbus, the fieldbus is laid out across the plant, and field devices are connected to the fieldbus to control the plant while communicating with each other.

In this type of plant control, instruments positioned in the field are made intelligent so that control functions can be distributed in the field.

As an example of a plant control system using a fieldbus, there is the invention developed by the applicant concerned and described in Japanese Laid-open Patent Application 1999-177401.

FIG. 1 is a schematic view illustrating one example of a plant control system using the fieldbus.

In FIG. 1, an operation and monitoring station HIS is connected to bus 1 for communication purposes. A field control station FCS is connected to buses 1 and 2 for communication purposes. Fieldbus 5 is connected through interface equipment 4 to bus 2. Field devices 61 to 6n are connected to field bus 5 and are equipped with control functions. In the figure, sensors are illustrated as the field devices.

In such a plant control system as described above, the plant is controlled by a distributed control system comprising the operation and monitoring station HIS and the field control station FCS, as well as by field devices 61 to 6n.

The Foundation Fieldbus is available as one of the fieldbus standards. Field devices compatible with the Foundation Fieldbus standard retain the results of self-diagnosis as bit-string parameters.

In addition, these field devices have two or more parameters that are useful for identifying their device statuses. By reading these parameters, it is possible to check the devices for possible failures.

However, the following problems have been inherent in such conventional field devices:

(a) Without in-depth knowledge about FF-H1 (a fieldbus specification) and the fieldbus, it is not possible to know which parameter to read.

(b) In some cases, parameters that need to be read do not belong to any single block (field device) but cut across two or more blocks. It is therefore difficult to read all these parameters at the same time.

(c) Even if parameters can be successfully identified and read, it is difficult to determine the degree of importance from parameters provided in bit string format.

(d) Even if alarm information is provided on the liquid crystal display (LCD) of a field device installed in the field, it is not possible to visually check the alarm information unless someone goes all the way out to the field and views the LCD of the field device.

### SUMMARY OF THE INVENTION

The present invention has been developed in order to address the above-mentioned problems. An object of the present invention is, therefore, to realize a data display unit for use with field devices which makes it possible to easily obtain parameters necessary to know the status of a field device without the need for in-depth knowledge about the parameters, to display the obtained parameters in an easy-to-understand format, and to identify the parameters without having to go out to the site where the field device is installed.

### BRIEF DESCRIPTION OF DRAWINGS

FIG. 1 is a schematic view illustrating an example of plant control systems using a fieldbus.

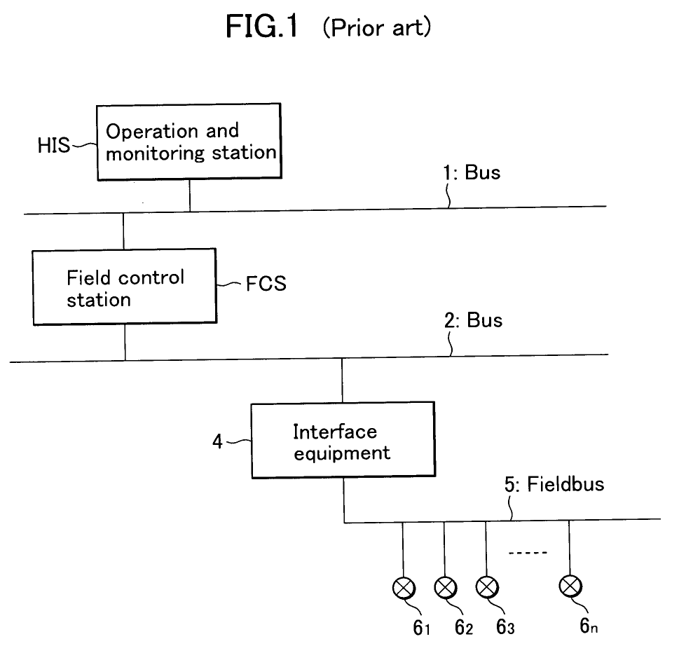

FIG. 2 is a schematic view illustrating one embodiment of the present invention.

FIG. 3 is a schematic view illustrating an example of screens provided on the system in FIG. 2.

FIG. 4 is a schematic view illustrating an example of the contents of a definition file for displaying on the screen of FIG. 3.

### DETAILED DESCRIPTION OF THE PREFERRED EMBODIMENTS

Preferred embodiments of the present invention are described in detail below with reference to the accompanying drawings.

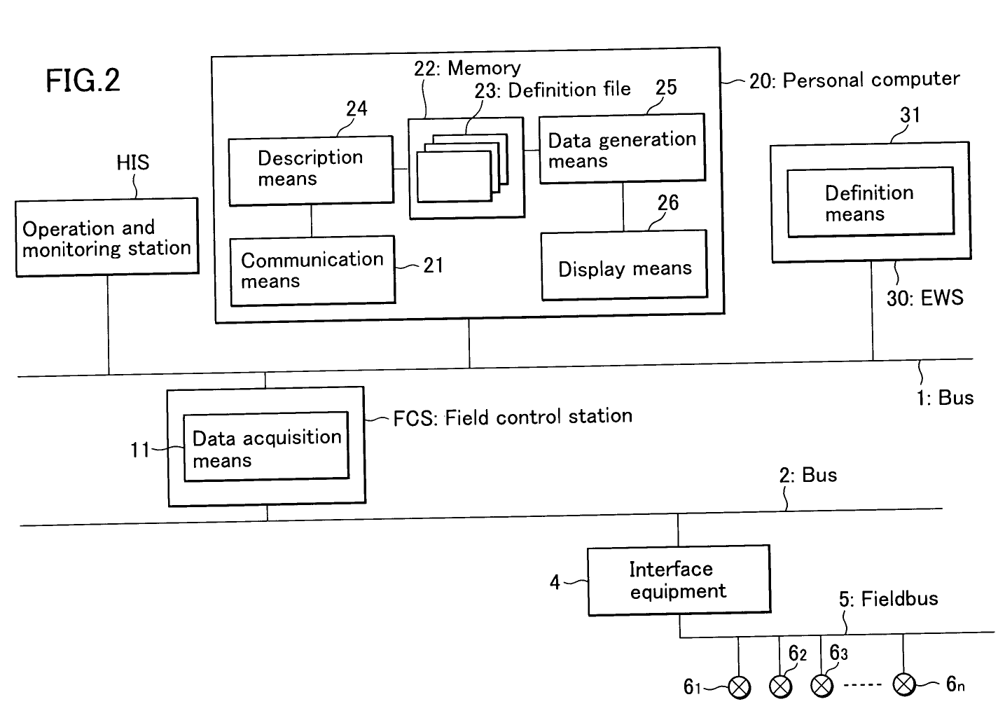

FIG. 2 is a schematic view illustrating one embodiment of the present invention. In FIG. 2, elements identical with those of the preceding figure or figures are referenced alike.

In FIG. 2, personal computer 20 and engineering workstation (abbreviated as EWS) 30 are connected to bus 1 for communication purposes. Personal computer 20 is a terminal used to view the data of field devices. EWS 30 is a station included to configure the system.

Data acquisition means 11 for reading data from field devices 61 to 6n is provided in the field control station FCS. Data acquisition means 11 is implemented using data acquisition functions inherent in the field control station FCS.

Communication means 21 performs communication tasks according to the communication protocols of bus 1. Data acquired by data acquisition means 11 is sent to personal computer 20 while communication means 21 communicates with the field control station FCS.

Definition file 23 comprises definitions for each field device and is stored in memory 22. In the illustrated example, respective definition files are provided for field devices 61 to 6n. Definition file 23 is written in a predetermined format, thus defining the way the data of field devices is displayed.

Data read by data acquisition means 11 is transmitted to description means 24 through communication means 21. Description means 24 writes the transmitted data to definition files according to the predetermined format to create files that define the way the data of field devices is displayed.

Data generation means 25 interprets definition files wherein data is written, in order to generate display data.

Display means 26 displays the generated display data on the personal computer on the network. The data displayed includes the diagnostic parameters of field devices and the statuses thereof, as well as alarms present in the field devices.

EWS 30 has definition means 31 which is used during engineering work for building a system in order to define diagnostic parameters to be displayed. Definition means 31 defines diagnosis parameters to be displayed on afield device basis. The definition means adds or deletes a definition file or files when a field device or devices are added or removed.

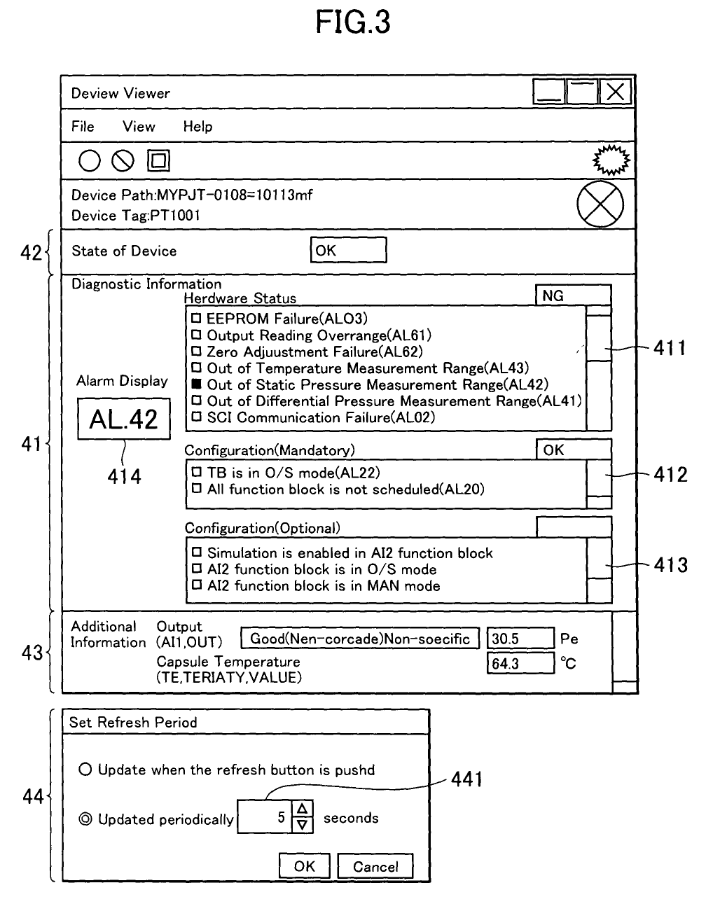

FIG. 3 is a schematic view illustrating an example of screens provided on the system in FIG. 2.

In FIG. 3, diagnostic information is displayed in area 41. Hardware status parameters are displayed in subarea 411 of area 41. Likewise, mandatory configuration parameters and optional configuration parameters are displayed in subareas 412 and 413, respectively.

A box for indicating the presence/absence of failures is shown to the left of each parameter. Boxes for parameters that are normal are marked white (□), while boxes for parameters that are abnormal are marked black (▪). In the illustrated example, the parameter “Out of Static Pressure Measurement Range (AL.42)” is abnormal. A message “NG” is therefore shown outside subarea 411. In contrast, a message “OK” is shown outside subarea 412 since all parameters in the subarea are normal.

Since the parameter “Out of Static Pressure Measurement Range (AL.42)” is abnormal, “AL.42” is indicated in alarm display subarea 414. If there are two or more alarms raised, the alarm display subarea indicates the alarms in a successive, cyclical order.

Area 42 displays device information. In the illustrated example, “OK” is indicated.

Area 43 displays additional information. In the illustrated example, an output level and capsule temperature are indicated.

Area 44 is used to set an update interval. The update interval is the interval at which the data acquisition means reads data from field devices.

In order to read data at a fixed interval, the button labeled “Update periodically” is clicked and the interval is set in box 441. The data acquisition means reads data from field devices at this preset interval.

In order to read data at any desired point in time, the button labeled “Update when the refresh button is pushed” is clicked. The data acquisition means reads data from field devices at the point in time when the button is clicked.

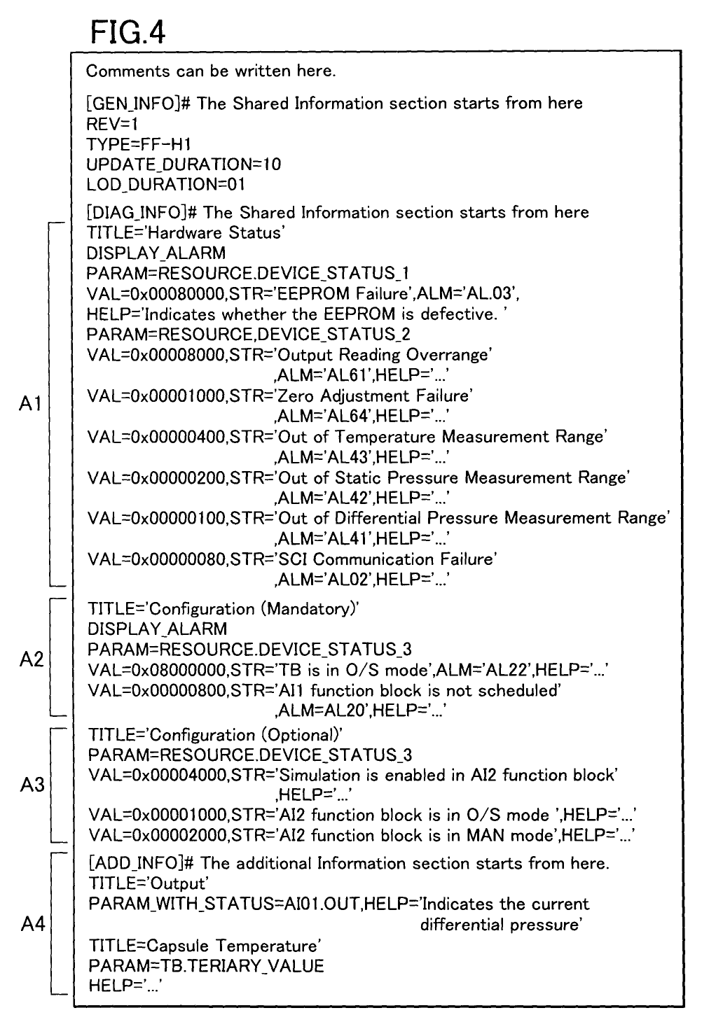

FIG. 4 is a schematic view illustrating an example of the contents of a definition file for displaying the screen shown in FIG. 3.

Definition files are written according to a predetermined format.

In FIG. 4, statements indicated by A1 define the way parameters that represent the hardware status are displayed. Specifically, the statements define which alarm should be displayed under what conditions. For example, one of the statements defines that alarm AL.03 is to be indicated if an EEPROM fails. The statement also describes the meaning of read data indicated in a bit string format.

As described above, conditions for displaying alarms are defined in definition files. Therefore, if there is any alarm information displayed on the LCD of a field device located in the field, it is possible to view the alarm information on the screen of the personal computer without having to go out to the field to view the LCD screen.

By the statement “DISPLAY_ALARM,” it is defined that “OK” or “NG” be indicated.

Statements indicated by A2 define the way the parameters of mandatory configurations are displayed. Statements indicated by A3 define the way the parameters of optional configurations are displayed. Statements indicated by A4 define the way additional information is displayed.

It should be noted that although in the above-described embodiment a case has been described in which the data display unit is applied to field devices compatible with the Foundation Fieldbus standard, it is also possible to apply the data display unit to other field devices that have diagnostic parameters other than those mentioned above. For example, the data display unit may be applied to HART devices.

According to the present invention, the following advantageous effects are provided:

(1) Definition files that define the way the data of field devices is displayed are created and the field device data is displayed according to these definition files, thus providing the following advantageous effects:

(a) It is possible to easily obtain parameters necessary to know the status of a field device without the need for in-depth knowledge about the parameters.

(b) It is possible to display the bit-string data of field devices in an easy-to-understand format.

(c) Since the data of field devices are indicated on a personal computer on a network, it is possible to identify the data without having to go out to the site where the field devices are installed.

(d) Since definition files are used to define the way information is displayed, it is possible to display the information in a standardized format even if field device models differ from each other.

(2) Since definition files are created on a field device basis, the above-described advantageous effects are available for each field device.

(3) Since definition files define the way the diagnostic parameters of field devices are displayed, it is possible to display parameters necessary to diagnose the field devices in an easy-to-understand manner, thereby facilitating the diagnosis of the field devices.

(4) Since definition files are created on a field device basis, it is possible to display parameters necessary for diagnosis on a field device basis in an easy-to-understand manner.

(5) Definition files define under which conditions alarms should be displayed. Consequently, if there is any alarm information displayed on the LCD of an on-site field device, it is possible to view the alarm information on the screen of a personal computer, without having to go out to the site to view the LCD screen.

(6) The display means has an area for setting an update interval at which data acquisition means reads data from field devices. Consequently, it is possible to easily set the interval at which data is read from the field devices on the screen of a personal computer.

(7) The area for setting an update interval is provided with a refresh button that allows the data acquisition means to read data from field devices at a desired point in time. Consequently, it is possible to easily set the point in time at which data is read from the field devices, on the screen of a personal computer.

(8) Since a definition means for defining diagnostic parameters to be displayed on a field device basis is provided, it is possible to add or delete a definition file or files according to whether a field device or devices are added or removed. Consequently, it is possible to easily cope with the addition or removal of field devices.

What is claimed is:

1. A data display unit for use with field devices, comprising:
data acquisition means for reading data from field devices connected to a fieldbus;
description means for writing data read by said data acquisition means to definition files according to a predetermined format to create definition files that define the way the data of said field devices is displayed;
generation means for interpreting said definition files wherein data is written to generate display data; and
display means for displaying said generated display data on a personal computer on a network.

2. A data display unit for use with field devices as claimed in claim 1, wherein said definition files are provided on a field device basis.

3. A data display unit for use with field devices as claimed in claim 1 or 2, wherein said definition files define the way the diagnostic parameters of said field devices are displayed and said display means displays the diagnostic parameters of said field devices and the statuses thereof according to definitions provided in said definition files.

4. A data display unit for use with field devices as claimed in claim 1 or 2, wherein said definition files are provided on a field device basis, each of said definition files defines the way the diagnostic parameters of each of said field devices, and said display means separately displays the diagnostic parameters of a plurality of field devices and the statuses thereof on a field device basis according to definitions provided in said definition files.

5. A data display unit for use with field devices as claimed in claim 1, 2, 3, 4 or 5, wherein said definition files define under what conditions alarms should be displayed and said display means displays alarms present in said field devices according to definitions provided in said definition files.

6. A data display unit for use with field devices as claimed in claim 1, 2, 3, 4 or 5, wherein said display means has an area for setting an update interval at which said data acquisition means reads data from said field devices and said data acquisition means reads data from said field devices at said update interval set in said update interval setting area.

7. A data display unit for use with field devices as claimed in claim 1, 2, 3, 4, 5 or 6, wherein said update interval setting area is provided with a refresh button that allows said data acquisition means to read data from said field devices at a desired point in time, and said data acquisition means reads data from said field devices at said desired point in time set using said refresh button.

8. A data display unit for use with field devices as claimed in claim 1, 2, 3, 4, 5, 6 or 7, further comprising definition means for defining diagnostic parameters to be displayed on a field device basis, wherein said description means writes to said definition files according to definitions provided in said definition means.
